(19) United States
(12) Patent Application Publication
(10) Pub. No.: US 2019/0087496 A1
(43) Pub. Date: Mar. 21, 2019

(54) Method and system to provide the search results for people search based on the approval

(71) Applicant: Johnson Manuel-Devadoss, Pearland, TX (US)

(72) Inventor: Johnson Manuel-Devadoss, Pearland, TX (US)

(73) Assignee: Johnson Manuel-Devadoss, Pearland, TX (US)

(21) Appl. No.: 15/706,630

(22) Filed: Sep. 15, 2017

(51) Int. Cl. G06F 17/30

(52) U.S. Cl. CPC G06F 17/30867; G06F 17/30988

(57) ABSTRACT

Disclosed is a method and system to provide the search results for a given user query based on user's approval. In one embodiment, when search query for a user initiated, then present invention retrieves the user contact information and sends the approval notification to display the search results. Displaying the search results for a given user search is controlled by the user action on approval notification. The present invention builds the approval notification and sends the approval request to the user presented in the search query once it receives the contact information from the search engine. The user receives the approval notification and takes the appropriate action on the search request on him/her. In another embodiment, the present invention collects the user action on the search request and communicates to the search engine for the searcher accordingly. Similarly, the collected user action may update to the plurality of search engines that may integrate with present invention.

### CROSS-REFERENCE TO RELATED APPLICATIONS

This application claims the benefit of U.S. Provisional Application No. 62/395,007, filed on Sep. 15, 2016, and incorporated by reference herein in its entirety.

### BACKGROUND OF INVENTION

### 1. Field of the Invention

The present invention relates to provide the privacy on the user information that is available in the World Wide Web. In particular, the present invention relates to a method and system for providing search results for the search query about people based on their approval.

### 2. Description of Related Art

At present a vast amount of information available in the World Wide Web that can be available for everyone for them to search and find information about a particular person. Whether the available information in the World Wide Web are true or not but people believes that information available in the World Wide Web or the search results about a particular person from web search engine. There is no security or privacy on the content that are available about people or there is no actual validation from the actual person about the information about him returned by the search engine.

Due to that there are a lot of possibility of misinterpretation about a particular person and also people stalking about other person without their knowledge by search and believing the information available in the World Wide Web or the information presented in the search results of web search engine. Hence, there is a need of a method and system to collect an approval from particular person whenever someone searches about him/her and based on the collected approval to determine whether the search engine may continue in processing the search query or not.

### SUMMARY OF THE INVENTION

Therefore, it is desired to develop and implement a technical solution to provide the approval notification and collect the approval from a particular person when someone search about a particular person and based on the collected approval to determine whether the search engine may continue in processing the search query or not.

In one embodiment of the present invention, there is provided a method for determining the search query that is related to the people search, retrieving the contact information of person who submits the search query and a person who is in the search query from search engine, sending the approval notification to the person when someone searches about him.

In another embodiment of the present invention, there is a provided method to retrieve the action that performed by the person on the approval notification for the search request on him.

In another embodiment of the present invention, there is a provided method to notify the action performed by particular person about the search performed on him to the search engine to determine to whether to continue in processing the search query for the user. Similarly, the collected user action may update to the plurality of search engines that may integrate with present invention.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary network in which systems and methods consistent with the principles of the invention may be implemented;

FIG. 2 is an exemplary diagram of a client and/or server of FIG. 1 according to an implementation consistent with the principles of the invention;

FIG. 3 is a flowchart of exemplary processing of the present invention of FIG. 1 according to an implementation consistent with the principles of the invention;

FIG. 4 is an exemplary functional block diagram of the present invention of FIG. 1 according to an implementation consistent with the principles of the invention; and

FIG. 5 is an exemplary operational sequence of the present invention of FIG. 1 according to an implementation consistent with the principles of the invention.

### DETAILED DESCRIPTION OF THE INVENTION

The following detailed description of implementations consistent with the principles of the invention along with accompanying drawings indicated above. The same reference numbers in different drawings may identify the same or similar elements. In addition, the following detailed description does not limit the invention.

Implementation consistent with the principles of the invention is directed to providing search results for the search query about people based on their approval.

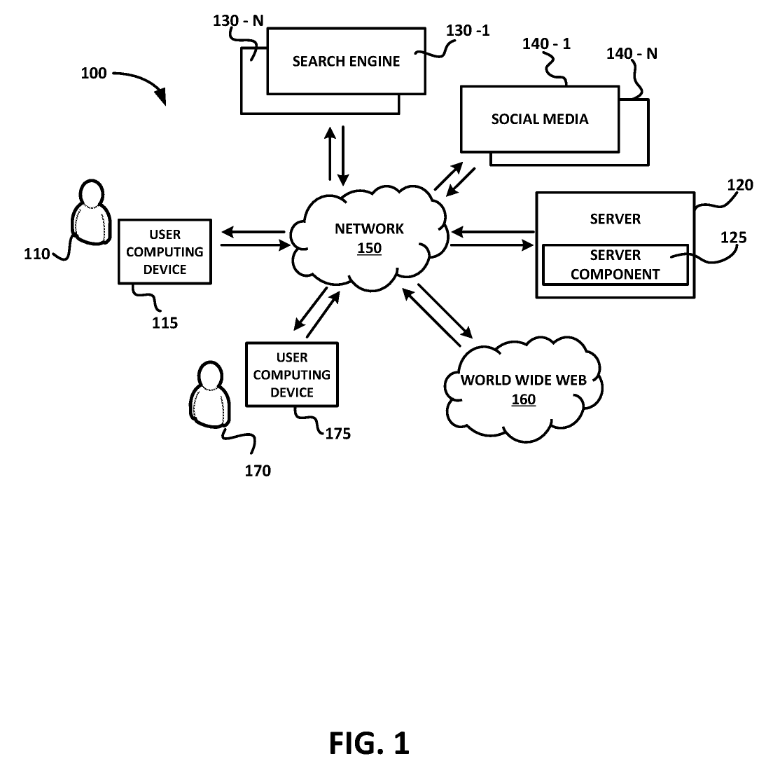

FIG. 1 is an exemplary diagram of a present invention 100 in which systems and methods consistent with the principles of the invention may be implemented. The present invention 100 may include multiple clients 115, 175 connected to server 120, web search engine servers 130-1, . . . , 130-N, social media servers 140-1, . . . , 140-N, world wide web 160 via a network 150. Two clients 115, 175, a single server 120, N servers 130, N servers 140, World Wide Web 160 have been illustrated as connected to network 150 for simplicity. In practice, there may be more or fewer clients and servers. Also, in some instances, a client may perform a function of a server and a server may perform a function of a client.

Clients 115, 175 may include client entities. An entity may be defined as a device, such as a personal computer, a wireless telephone, a personal digital assistant (PDA), a laptop, or another type of computation or communication device, a thread or process running on one of these devices, and/or an object executable by one of these devices. Servers 120, 130, 140 may include server entities that gather, process, search, and/or maintain web pages in a manner consistent with the principles of the invention.

In an implementation consistent with the principles of the invention, server 120 may include a server component 125 to providing search results for the search query about people based on their approval. Server component 125 is configured for determining the search query that is related to the people search, retrieving the contact information of person who submits the search query and a person who is in the search query from search engine, sending the approval notification to the person when someone searches about him. Also, server component 125 is configured to implement the method to retrieve the action that performed by the person on the approval notification for the search request on him.

Server component 125 is configured to implement the method to notify the action performed by particular person about the search performed on him to the search engine to determine to whether to continue in processing the search query for the user. Similarly, the collected user action may update to the plurality of search engines that may integrate with present invention. Server 120 may include the server entities such as application server, catalog server, communications server, computing server, database server, fax server, file server, game server, mail server, media server, print server, sound server, proxy server, and web server.

The social media servers 140, search engine servers 130 may be any combination of software agents and/or hardware modules for establishing a social media-based platform for users. The search engine servers 130, social media servers 140 may facilitate interaction and communication with server component 125 via the network 150. The search engine server 130-1, . . . , 130-N may register with server component 125 to provide the tight integration among search engine servers and server component 125 via the network 150. Similarly, the social media server 140-1, . . . , 140-N may register with server component 125 to provide the tight integration among search engine servers and server component 125 via the network 150. Whenever any people search performed on the search engine servers 130, social media server 140, the search engine server 130, social media server 140 may communicate to the server component 125 to collect the approval from the appropriate person prior to the search query processing.

The search engine servers 130, social media servers 140 may facilitate interaction and communication among users of the client devices 115, 175 via the network 150. For example, the social media servers 140, search engine servers 130 may provide a platform for users of the client devices 115, 175 who are members of the social network to upload photos and notes to share with other users of client devices 115, 175 who are also members of the same social network. In one embodiment, the social network server 140 may facilitate sharing of information about news and activities of members of the social network with other members designated as friends within the social network. The functionality of the social media-based platform may also be distributed across multiple servers disposed across the network 150.

Network 150 may include a local area network (LAN), a wide area network (WAN), a telephone network, such as the Public Switched Telephone Network (PSTN), an intranet, the Internet, a memory device, or a combination of networks. Clients 115, 175 and servers 120, 130, 140, and 160 may connect to network 150 via wired, wireless, and/or optical connections.

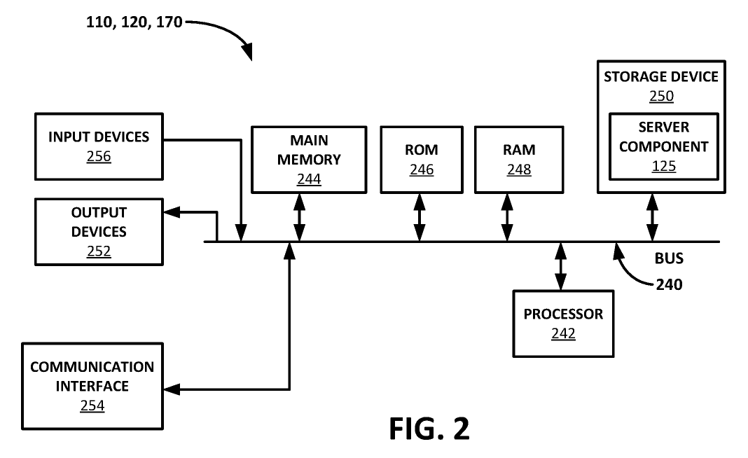

FIG. 2 is an exemplary diagram of a client or server entity (hereinafter called “client/server entity”), which may correspond to one or more of clients 115, 175 and servers 120, 130, 140, according to an implementation consistent with the principles of the invention. The client/server entity may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity.

Processor 220 may include one or more conventional processors or microprocessors that interpret and execute instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity, such as a keyboard, a mouse, a pen, voice recognition and/or biometric mechanisms, etc. Output device(s) 270 may include one or more conventional mechanisms that output information to the operator, including a display, a printer, a speaker, etc. Communication interface 280 may include any transceiver-like mechanism that enables the client/server entity to communicate with other devices and/or systems. For example, communication interface 280 may include mechanisms for communicating with another device or system via a network, such as network 150.

As it will be described in detail below, the client/server entity, consistent with the principles of the invention, perform certain searching, generating user notification with their activities, updating the user activities to their subscribed social media websites related operations. The client/server entity may perform these operations in responses to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. The software instructions contained in memory 230 may cause processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

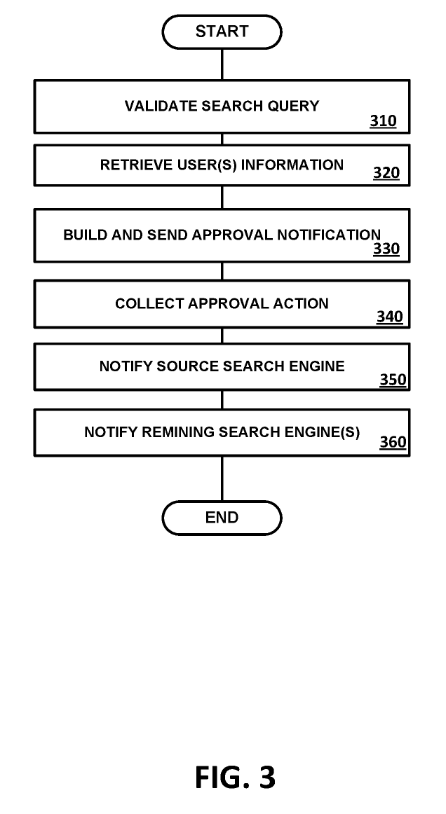

FIG. 3 is a flowchart of exemplary processing of the present invention of FIG. 1 according to an implementation consistent with the principles of the invention. In step 302, user submits a search query to find information about a particular person. The submitted search query may validate to determine whether it is related to the people search by the search engine 130, 140. The search engine 130, 140 sends the federated approval to the present invention server 125. In step 320, server component 125 requests the plurality of search engine 130, 140 to retrieve the information about a person who submit the search query and search about a particular person. Presently, most of search engines 130-1, . . . , 130-N and social media 140-1, . . . , 140-N servers are storing their users contact information such as phone number, email address on the user profile database.

The server component 125 retrieves the searcher and person who is in the search query contact information from the user profile database of the requested search engine. In step 330, the server component 125 builds the approval notification for the given search query. The approval notification message may comprise URL with the searcher information such as contact information, picture, and submitted search query. Once the approval notification message has been built, it may send to the person via SMS to the phone number, email to the retrieved email address. When person clicks on the URL from the notification message, he/she may approve or rejects once he/she verifies the search information and what she/he search about him/her. The approval action may record from the URL. The URL is nothing but server component hosted in the server 120 and server component 125 stores the person action on the notification as shown in Step 340.

Example, when user ‘A’ submits a search query (i.e., “User B details”) about user ‘B’ on Facebook (i.e., social media 140-1). Since Facebook (i.e., social media 140-1) may tightly integrate with server component 125, Facebook sends request to the server component 125 to retrieve the approval from user ‘B’ on the submitted search query from user ‘A’. The server component 125 may request the Facebook server 140-1 to retrieve the contact information such as email address, phone number, picture from user profile database for the user ‘A’ and user ‘B’. Once the contact information may retrieve from the contact database, the server component 125 builds the approval notification web page that may comprise of submitted search query (i.e., “User B details”), user ‘A’ phone number, email address, picture of user ‘A’.

The built approval notification web page may host in the server 120. The approval notification web page may include in the notification message that send to the User ‘B’ via SMS to his/her mobile computing device and email to his/her email address. User ‘B’ receives the notification from the server 120, opens the notification (i.e., SMS or Email) either from his/her mobile computing device or computing device and clicks on the web page URL from the notification to approve or reject. When User ‘B’ clicks on the URL, the URL is nothing but the web page that may host in the server 120. When User ‘B’ clicks either ‘Approve’ or ‘Reject’ after verifying the User ‘A’ information presented in the web page, the server component 125 records the User ‘B’ action and stores it accordingly. Once User ‘B’ approval action retrieved, the server component 125 may communicates to the Facebook (i.e., social media 140-1) about User ‘B’ action on User ‘A’ search request for User ‘B’. Similarly, the server component 125 may checks whether User ‘A’ and User ‘B’ exists in other social media 140-2, . . . , 140-N and search engine 130-1, . . . , 130-N that are integrated with server component by searching using User ‘A’ and User ‘B’ contact information. The User ‘B’ action on User ‘A’ search request may communicate to the social media 140-2, . . . , 140-N and search engine 130-1, . . . , 130-N If User ‘A’ and User ‘B’ exists. In step 350, collected approval action may send to the source search engine. In step 360, the collected user action may update to the plurality of search engines that may integrate with present invention.

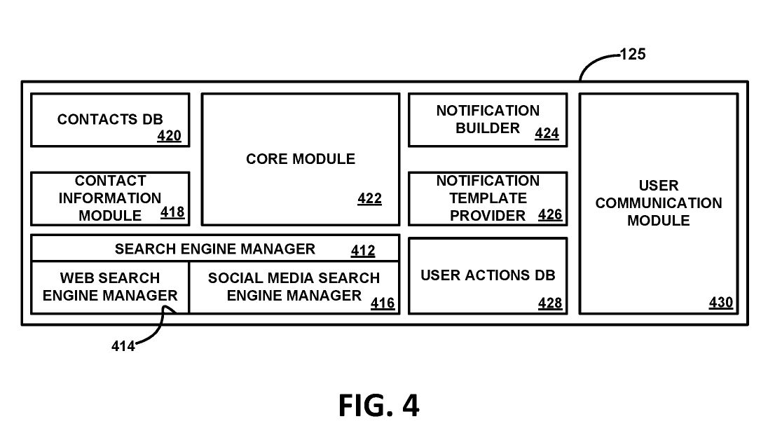

FIG. 4 is an exemplary functional block diagram of the present invention of FIG. 1 according to an implementation consistent with the principles of the invention. The present invention is a computer-implemented method and system 125 to provide a privacy on user information that is available in the World Wide Web. The computer-implemented method and system 125 comprises of search engine manager 412 module, contact information module 418, contacts db 420, core module 422, notification builder module 424, notification template provider module 426, user actions db 428, and user communication module 430. The search engine manager module 412 further comprises of web search engine manager module 414, social media search engine manager module 416.

The search engine module 412 is responsible for interacting with provided search engine application programming interface to establish the communication path between present invention and a plurality of search engines. In a typical situation, search engine module 412 is configured to use representational state transfer (REST) API to communicate with search engine API. In one embodiment, user may provide a plurality of search engines when using the present invention. By default, present invention comprises a plurality of search engines and it may allow users to add or remove a particular search engine from the list. In one embodiment, the web search engine manager 414 may retrieve a plurality of web search engines from the user provided search engines and establish the communication via REST API. Similarly, the social media search engine manager 416 may retrieve a plurality of social media sites from user provided search engines and establish the communication via REST API. The user interactions may record to search engines and social media sites using web search engine manager 414, and social media manager 416 modules.

The contact information module 418 is responsible for retrieving the user profile information for the user in the search query and the user who initiated the search query. In one embodiment, user information may have collected during user profile setup before the present invention search functionality is being used. The collected user profiles are being stored into Contacts DB 420 and interaction about the user profile information is being handled by contact information module 418.

The core module 422 is the main module of computer implemented method and system 125 which receives the user search query and retrieves the user profile information for the user in the search; initiates the notification builder to build the approval notification from user; communicates to the user on their preferred way of communication to retrieve their approval; propagating the user approval on appearing his/her information in the search results to partnered social media sites and web search engine.

The Notification module 424 retrieves the notification messages along with the user information and the message template from the notification template provider 426 and sends the new notifications to the user depending on their preferred notification method via user communication module 430. The Notification module 424 leverages Core Module 422 and retrieves the preferred notification method from the contacts DB 420 using the user information. The approved notification messages along with the user information and the notification message are received by the Notification module 424. The notification template provider module 426 holds a plurality of message templates in an XSLT format which may have used to build a custom message notification with searcher information, given search query words. The notification module 424 may leverage the notification template provider module 426 to build the notification messages to user.

In one embodiment, the present invention tracks the user action for the provided action notification for the search action taken by another user. In some embodiment, the notification may include the separate web page to redirect user to take an action to record the user action. In next event, if same user initiates the search query for the given user again then notification may have sent to user with his/her previous action taken and seeks his/her approval or change in approval.

User communication Module 430 is the communication protocol to determine to send the notification to user. In one embodiment, the approval notification may have sent via email where user take an action from the email by clicking on the URL in the message. In another embodiment, the approval notification may have sent via short message (SMS) to user mobile computing device to take an action. Hence, the user communication module 430 may have configured to send an email notification as well as send a notification message to the user mobile computing device.

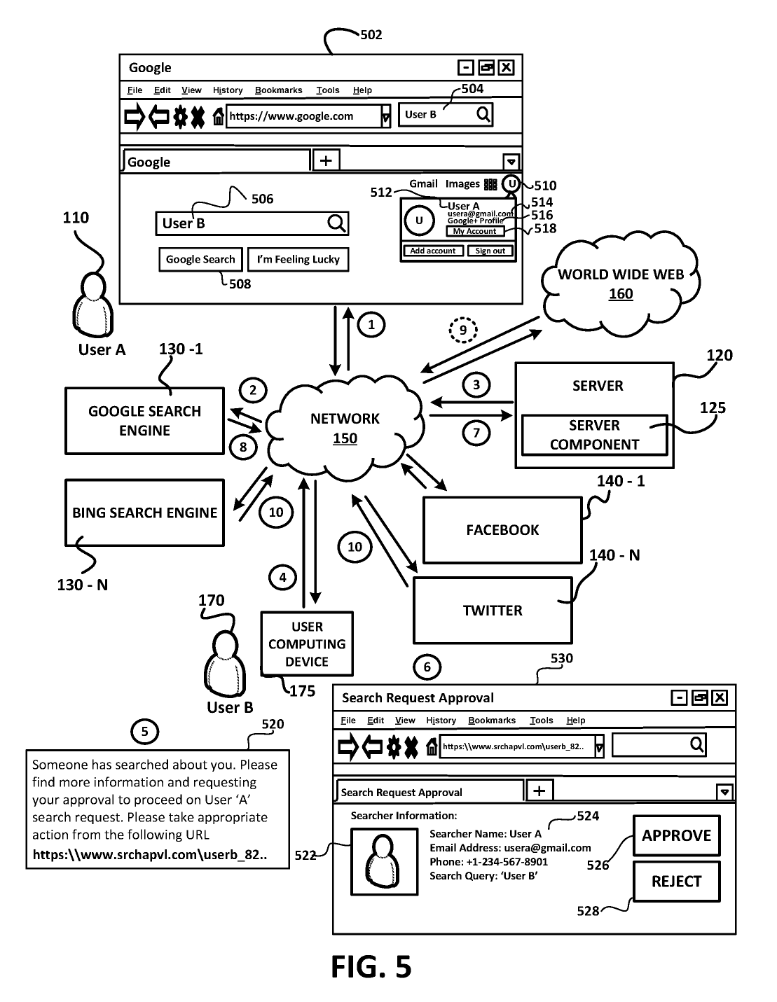

FIG. 5 is an exemplary operational sequence of the present invention of FIG. 1 according to an implementation consistent with the principles of the invention. As shown in sequence 1, user A 110 opens up the web browser 502 and initiates the search query (i.e., “User B”) on google search engine either via search add-on 504 or actual search window 506. User A logged into google using his/her credentials and as shown in 510 top right corner shows he/she logged information. When click on the icon 510 it may expand and gives more details such as name 512, email 514, google+profile 516, my account 518. It shows google search engine stores User A information such as email address, picture, phone number on the user profile database.

The present invention leverages this features to obtain the User A and User B contact information from the user profile database with Google's permission. When User A clicks on Google Search button 508, web browser sends the search request to google search engine server 130-1 via network 150 as shown in sequence 2. Google search engine may subscribe with present invention server component to establish the tighter integration with present invention via network 150. Google Search Engine server 130-1 sends the request to the server component 125 via network to obtain the approval from User B for the search request from User A.

In sequence 3, the server component 125 sends the request to google search engine server 130-1 to request permission to access the user profile database to retrieve the contact information of User A and User B. In some embodiment, if User B information is not available in the user profile database or user B contact information could not be retrieved by the present invention then it may treat User B as the anonymous user and it may not send the approval notification if contact information may not able to retrieve by the present invention. In some other embodiment, the present invention may implement to provide the independent search engine with storing users information in the user profile database instead of depending on the other search engine to produce the results. It may also provide the users to search results based on the user's approval who may subscribed with present invention.

Once contact information for User A and User B exists in the google user profile database, then contact information for User A and User B may retrieved from the user profile database. Based on the retrieved information, a web page may construct with User A details such as name, email address, phone, picture etc and constructed webpage may host in the server 120. The webpage URL is appended in the approval notification while building the notification message for User B. Once approval notification message may construct, it sends to the User B 170 computing device 175 via network as shown in Sequence 4. In sequence 5, User B 170 receives the notification 520 on his/her computing device and then opens the notification to click on the URL from the notification message. When user B clicks on the URL provided in the notification message, he/she may have directed to the webpage 530 that may construct and host in the server as shown in sequence 6.

The webpage may include User A details 524 such as name, email address, phone and search query on User B along with Approve 526, and Reject 528 button. When user B takes action on approving or rejecting the search request for User A by clicking either on Approve 526 or Reject 528 button. In sequence 7, the server component collects the user B action on the user A search request and stores the appropriate User B action in the Users Action DB. In sequence 8, the server component 125 communicates the User B action on the user A search request to the google search engine server 130-1. Google Search Engine server may stop or continue in processing (sequence 9) the User A search request on User B based on the User B approval. In sequence 10, the server component 125 updates the User B action on User A search request about User B to the plurality of search engine servers 130-N and social media servers 140-1, . . . , 140-N if User A and User B are exists in 130-N, 140-1, . . . , 140-N.

Implementations consistent with the principles of the invention may leverage user subscribed information to search for latest user activities in the web. Information found about the user and user interests are sent to user for review. After user approves messages the messages are posted to user preferred social media websites.

The foregoing description of implementations consistent with the principles of the invention provides illustration and description, but is not intended to be exhaustive or to limit the invention to the precise form disclosed. Modifications and variations are possible in light of the above teachings or may be acquired from practice of the invention.

For example, while series of acts have been described with regard to FIG.3 and FIG.5, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A system comprising:
one or more processors; and
a computer-readable medium embodying instructions that, when executed by the one or more processors, cause the one or more processors to connect a multiple virtual desktop from the cloud using user biometric authentication, the instructions comprising instructions for:
receiving the request from search engine server at server component to request approval from second user for a search request of first user;
responding back to search engine with requesting access to retrieve the contact information for first and second user from user profile database;
creating a webpage with first user contact information and hosting created webpage at server;
building approval notification message with hosted webpage URL and communicating the built approval notification message to the computing device of second user;
collecting second user action on the notification for first user search request on second user;
communicating collected second user action on the search request for first user to search engine said in receiving the request;
communicating collected second user action on the search request for first user to the plurality of search engine that are integrated.

2. The system according to claim 1, wherein said contact information comprises of Phone number, email address, picture.

3. The system according to claim 1, wherein said approval notification message is email, SMS, MMS.

4. The system according to claim 1, wherein said computing device of second user is mobile computing device, computer, laptop, PDA.

5. A method performed by one or more devices, the method comprising:
receiving the request from search engine server at server component to request approval from second user for a search request of first user;
responding back to search engine with requesting access to retrieve the contact information for first and second user from user profile database;
creating a webpage with first user contact information and hosting created webpage at server;
building approval notification message with hosted webpage URL and communicating the built approval notification message to the computing device of second user;
collecting second user action on the notification for first user search request on second user;
communicating collected second user action on the search request for first user to search engine said in receiving the request;
communicating collected second user action on the search request for first user to the plurality of search engine that are integrated.

6. The method according to claim 5, wherein said contact information comprises of Phone number, email address, picture.

7. The method according to claim 5, wherein said approval notification message is email, SMS, MMS.

8. The method according to claim 5, wherein said computing device of second user is mobile computing device, computer, laptop, PDA.

9. A non-transitory computer readable storage medium containing instructions that, when executed by at least one programmable processor, cause the at least one programmable processor to perform operations comprising:
receiving the request from search engine server at server component to request approval from second user for a search request of first user;
responding back to search engine with requesting access to retrieve the contact information for first and second user from user profile database;
creating a webpage with first user contact information and hosting created webpage at server;
building approval notification message with hosted webpage URL and communicating the built approval notification message to the computing device of second user;
collecting second user action on the notification for first user search request on second user;
communicating collected second user action on the search request for first user to search engine said in receiving the request;
communicating collected second user action on the search request for first user to the plurality of search engine that are integrated.

10. The non-transitory computer-readable storage medium according to claim 9, wherein said contact information comprises of Phone number, email address, picture.

11. The non-transitory computer-readable storage medium according to claim 9, wherein said approval notification message is email, SMS, MMS.

12. The non-transitory computer-readable storage medium according to claim 9, wherein said computing device of second user is mobile computing device, computer, laptop, PDA.
